(19) United States
(12) Patent Application Publication
(10) Pub. No.: US 2015/0327182 A1
(43) Pub. Date: Nov. 12, 2015

(54) SELF-CONFIGURATION OF POWER CONTROL PARAMETERS IN DENSE SMALL CELL DEPLOYMENTS

(71) Applicant: QUALCOMM INCORPORATED, San Diego, CA (US)

(72) Inventors: Ping Xia, San Diego, CA (US); Mehmet Yavuz, San Diego, CA (US); Chirag Sureshbhai Patel, San Diego, CA (US)

(73) Assignee: QUALCOMM INCORPORATED, San Diego, CA (US)

(21) Appl. No.: 14/275,645

(22) Filed: May 12, 2014

(51) Int. Cl. H04W 52/24

(52) U.S. Cl. CPC H04W 52/242

(57) ABSTRACT

A system for self-configuration of power control parameters based on path-loss is operable by a network entity that determines a default power parameter for an access terminal. The network entity determines a path-loss difference between a first path-loss for the access terminal to a serving cell and a second path-loss for the access terminal to a neighboring cell. A power control parameter is determined based on the default power parameter and the pass-loss difference. A system for self-configuration of power control parameters based on downlink power is operable by a network entity that determines a default power parameter for an access terminal. The network entity determines a downlink power difference between a downlink power of a serving cell and a downlink power of a neighboring cell. A power control parameter is determined based on the default power parameter, the downlink power difference.

### BACKGROUND

This application is directed to wireless communications systems, and more particularly to methods and apparatuses for optimizing resource usage based on channel conditions and power consumption.

A wireless network may be deployed over a defined geographical area to provide various types of services (e.g., voice, data, multimedia services, etc.) to users within that geographical area. The wireless communication network may include a number of base stations that can support communication for a number of user equipments (UEs). A UE may communicate with a base station via the downlink and uplink.

The 3rd Generation Partnership Project (3GPP) Long Term Evolution (LTE) advanced cellular technology is an evolution of Global System for Mobile communications (GSM) and Universal Mobile Telecommunications System (UMTS). The LTE physical layer (PHY) provides a highly efficient way to convey both data and control information between base stations, such as eNBs, and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

Small, lower-power base stations (e.g. small cells, femtocells, microcells, or picocells) often operate in a home or business. For example, a user of a mobile device served by a macro base station may switch to service by a small cell when in proximity of the user's home. In some situations, a mobile device served by a small cell, because of shorter transmission distance between the small cell and the mobile device, often enjoys a high signal to noise ratio (SINR) and more reliable communication.

In modern cellular networks especially the ones comprising small cell deployments, cell sizes can be very different. Different types of base stations have different max power limitations. For example, a macrocell may operate with about 43 dBm transmit power while a small cell may operate with about 23 dBm. In general, a cell with higher transmit power than its neighbors will also have a larger cell size.

Such unequal cell sizes may lead to uplink interference from mobile devices communicating with their serving base stations. In particular, a great amount of uplink interference is caused by user equipment (UE) served by large cell base stations and located near the large cell's edge. Because of the high uplink transmission power required to communicate with the large cell from the cell's edge, such UE cause major interference to nearby small cell base stations. Therefore, the large cell does not experience much interference, while the small cell is severely interfered by cell edge UEs of the neighboring large cell. In this context, there remains a need for improved techniques for optimizing uplink power for mobile devices to reduce interference.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In accordance with one or more aspects of the examples described herein, there is provided a system and method for self-configuration of power control parameters in dense small cell deployments. In one example, a network entity determines a default power parameter for an access terminal. The network entity determines a path-loss difference between a first path-loss for the access terminal to a serving cell and a second path-loss for the access terminal to a neighboring cell. A power control parameter is determined based on the default power parameter and the pass-loss difference.

In a second example, a network entity determines a default power parameter for an access terminal. The network entity determines a downlink power difference between a downlink power of a serving cell and a downlink power of a neighboring cell. A power control parameter is determined based on the default power parameter, the downlink power difference.

### BRIEF DESCRIPTION OF THE DRAWINGS

These and other sample aspects of the disclosure will be described in the detailed description and the appended claims that follow, and in the accompanying drawings, wherein:

FIG. 1A shows an illustration of an example wireless communication network;

FIG. 1B shows an example wireless communication system for self-configuration of power control parameters;

FIG. 1C shows a block diagram of an example wireless communication system for self-configuration of power control parameters;

FIG. 1D shows a block diagram of a second example wireless communication system for self-configuration of power control parameters;

FIG. 2 shows a block diagram of example communication system components;

FIG. 3 illustrates an example of a methodology for self-configuration of power control parameters;

FIG. 4 shows an example of an apparatus for self-configuration of power control parameters in accordance with the methodology of FIG. 3;

FIG. 5 illustrates an example of a methodology for self-configuration of power control parameters; and

FIG. 6 shows an example of an apparatus for self-configuration of power control parameters in accordance with the methodology of FIG. 5.

### DETAILED DESCRIPTION

Techniques for self-configuration of power control parameters in dense small cell deployments are described herein. The subject disclosure provides methods and apparatuses for reducing interference in cellular networks with a variety of different cell sizes. Such unequal cell sizes may lead to uplink interference from mobile devices communicating with their serving base stations. A power control parameter may be optimized to control cell uplink power for reducing interference.

In the subject disclosure, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The techniques may be used for various wireless communication networks such as wireless wide area networks (WWANs) and wireless local area networks (WLANs). The terms “network” and “system” are often used interchangeably. The WWANs may be code division multiple access (CDMA), time division multiple access (TDMA), frequency division multiple access (FDMA), orthogonal frequency-division multiple access (OFDMA), single carrier frequency division multiple access (SC-FDMA) and/or other networks. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). A WLAN may implement a radio technology such as IEEE 802.11 (Wi-Fi), Hiperlan, etc.

As used herein, the downlink (or forward link) refers to the communication link from the base station to the UE, and the uplink (or reverse link) refers to the communication link from the UE to the base station. A base station may be, or may include, a macrocell or microcell. Microcells (e.g., picocells, home nodeBs, and small cells) are characterized by having generally much lower transmit power than macrocells, and may often be deployed without central planning. In contrast, macrocells are typically installed at fixed locations as part of a planned network infrastructure, and cover relatively large areas.

The techniques described herein may be used for the wireless networks and radio technologies mentioned above as well as other wireless networks and radio technologies. For clarity, certain aspects of the techniques are described below for 3GPP network and WLAN, and LTE and WLAN terminology is used in much of the description below.

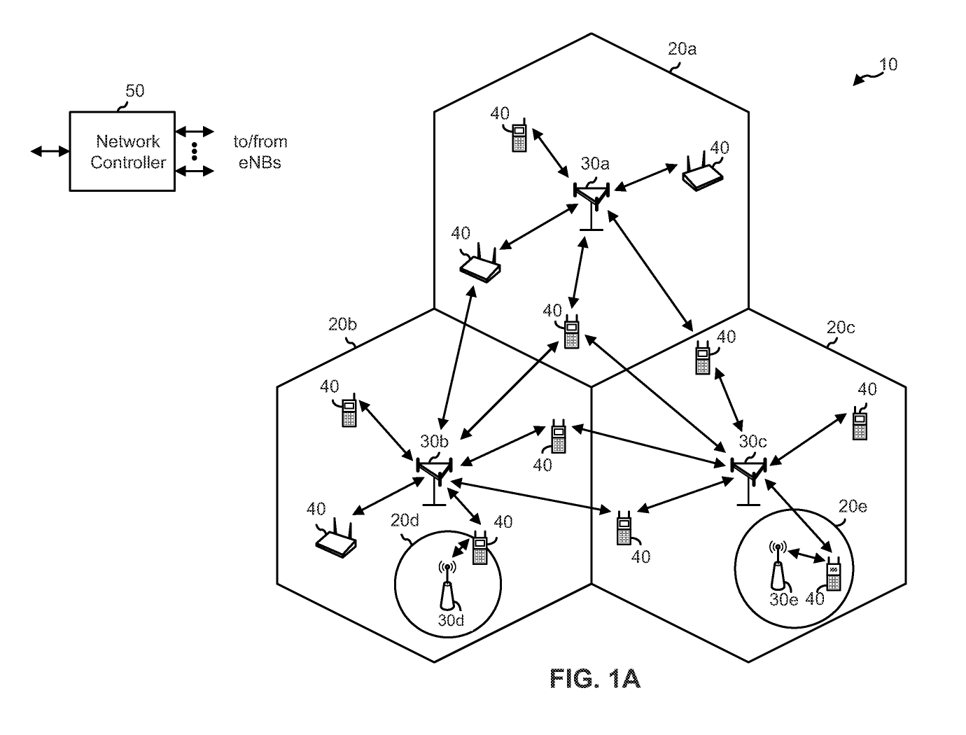

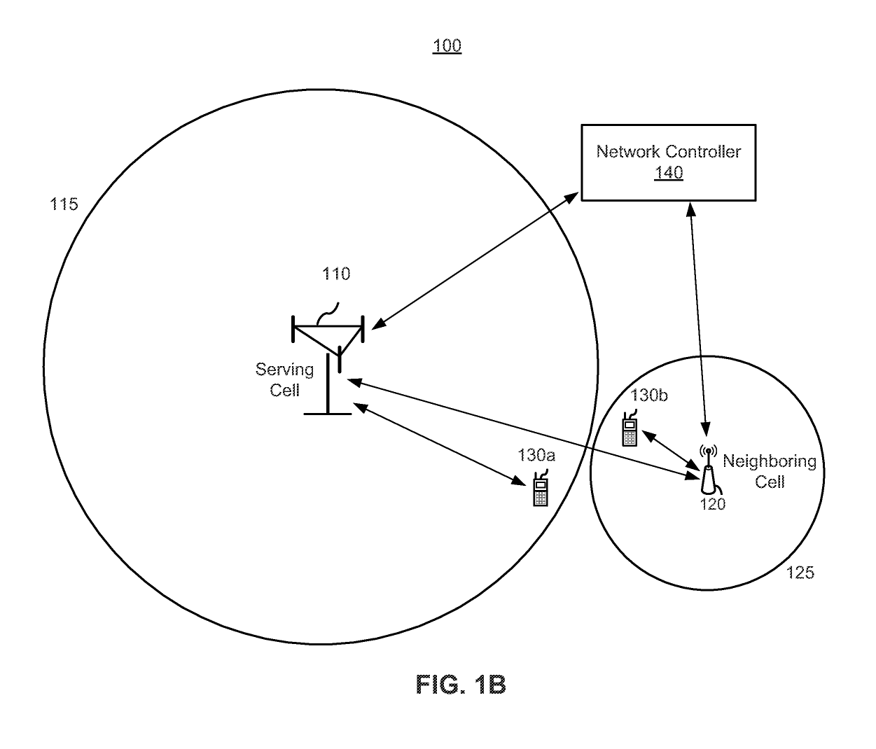

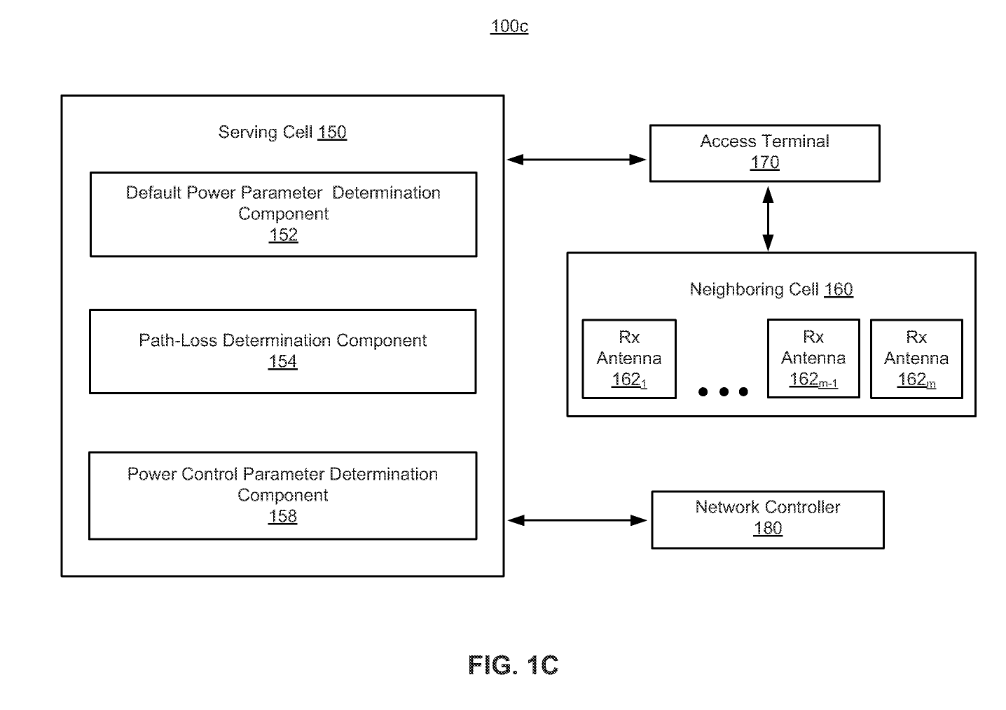

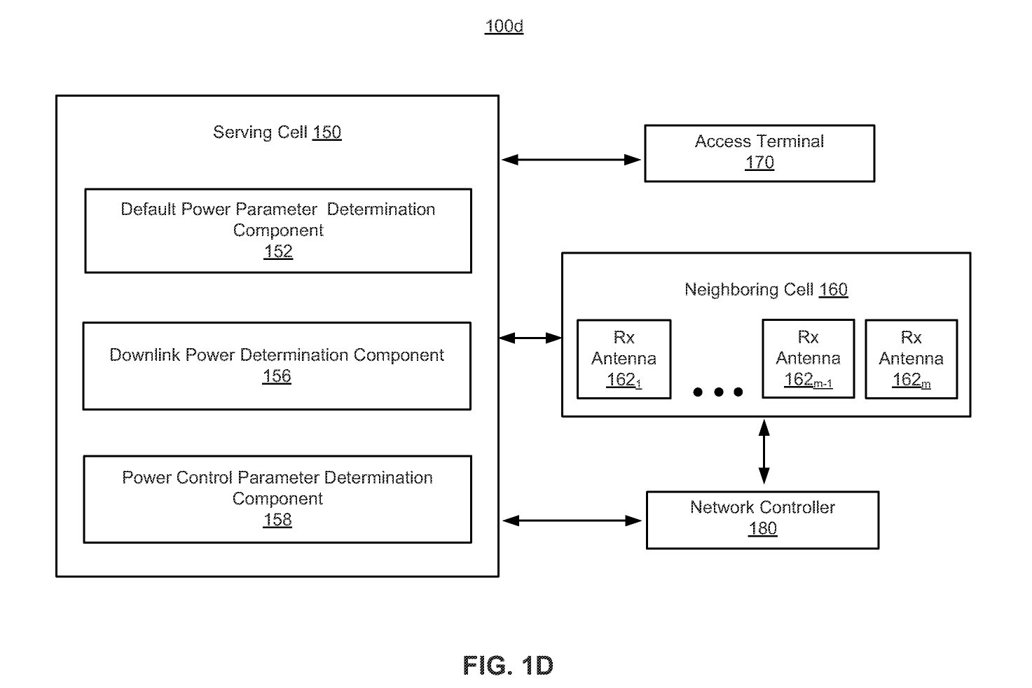

FIG. 1A is an illustration of an example wireless communication network 10, which may be an LTE network or some other wireless network. Wireless network 10 may include a number of eNBs 30 and other network entities. An eNB may be an entity that communicates with mobile entities and may also be referred to as a base station, a Node B, an access point, etc. Although the eNB typically has more functionalities than a base station, the terms “eNB” and “base station” are used interchangeably herein. Each eNB 30 may provide communication coverage for a particular geographic area and may support communication for mobile entities located within the coverage area. To improve network capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area, depending on the context in which the term is used.

An eNB may provide communication coverage for a macrocell, a small cell, a picocell, a microcell, or other types of cell. A macrocell may cover a relatively large geographic area (e.g., several kilometers in radius) and may allow unrestricted access by UEs with service subscription. A picocell may cover a relatively small geographic area and may allow unrestricted access by UEs with service subscription. A small cell may cover a relatively small geographic area (e.g., a home) and may allow restricted access by UEs having association with the small cell (e.g., UEs in a Closed Subscriber Group (CSG)). In the example shown in FIG. 1A, eNBs 30a, 30b, and 30c may be macro eNBs for macrocell groups 20a, 20b, and 20c, respectively. Each of the cell groups 20a, 20b, and 20c may include a plurality (e.g., three) of cells or sectors. An eNB 30d may be a pico eNB for a picocell 20d. An eNB 30e may be a small cell eNB, a small cell base station, or a small cell access point for a small cell 20e.

Wireless network 10 may also include relays (not shown in FIG. 1A). A relay may be an entity that can receive a transmission of data from an upstream station (e.g., an eNB or a UE) and send a transmission of the data to a downstream station (e.g., a UE or an eNB). A relay may also be a UE that can relay transmissions for other UEs.

A network controller 50 may couple to a set of eNBs and may provide coordination and control for these eNBs. Network controller 50 may be a single network entity or a collection of network entities. Network controller 50 may communicate with the eNBs via a backhaul. The eNBs may also communicate with one another, e.g., directly or indirectly via a wireless or wireline backhaul.

UEs 40 may be dispersed throughout wireless network 10, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with eNBs, relays, etc. A UE may also be able to communicate peer-to-peer (P2P) with other UEs.

Wireless network 10 may support operation on a single carrier or multiple carriers for each of the downlink (DL) and uplink (UL). A carrier may refer to a range of frequencies used for communication and may be associated with certain characteristics. Operation on multiple carriers may also be referred to as multi-carrier operation or carrier aggregation. A UE may operate on one or more carriers for the DL (or DL carriers) and one or more carriers for the UL (or UL carriers) for communication with an eNB. The eNB may send data and control information on one or more DL carriers to the UE. The UE may send data and control information on one or more UL carriers to the eNB. In one design, the DL carriers may be paired with the UL carriers. In this design, control information to support data transmission on a given DL carrier may be sent on that DL carrier and an associated UL carrier. Similarly, control information to support data transmission on a given UL carrier may be sent on that UL carrier and an associated DL carrier. In another design, cross-carrier control may be supported. In this design, control information to support data transmission on a given DL carrier may be sent on another DL carrier (e.g., a base carrier) instead of the DL carrier.

Carrier aggregation allows expansion of effective bandwidth delivered to a user terminal through concurrent use of radio resources across multiple carriers. When carriers are aggregated, each carrier is referred to as a component carrier. Multiple component carriers are aggregated to form a larger overall transmission bandwidth. Two or more component carriers can be aggregated to support wider transmission bandwidths.

Wireless network 10 may support carrier extension for a given carrier. For carrier extension, different system bandwidths may be supported for different UEs on a carrier. For example, the wireless network may support (i) a first system bandwidth on a DL carrier for first UEs (e.g., UEs supporting LTE Release 8 or 9 or some other release) and (ii) a second system bandwidth on the DL carrier for second UEs (e.g., UEs supporting a later LTE release). The second system bandwidth may completely or partially overlap the first system bandwidth. For example, the second system bandwidth may include the first system bandwidth and additional bandwidth at one or both ends of the first system bandwidth. The additional system bandwidth may be used to send data and possibly control information to the second UEs.

Wireless network 10 may support data transmission via single-input single-output (SISO), single-input multiple-output (SIMO), multiple-input single-output (MISO), or MIMO. For MIMO, a transmitter (e.g., an eNB) may transmit data from multiple transmit antennas to multiple receive antennas at a receiver (e.g., a UE). MIMO may be used to improve reliability (e.g., by transmitting the same data from different antennas) and/or to improve throughput (e.g., by transmitting different data from different antennas).

Wireless network 10 may support single-user (SU) MIMO, multi-user (MU) MIMO, Coordinated Multi-Point (CoMP), etc. For SU-MIMO, a cell may transmit multiple data streams to a single UE on a given time-frequency resource with or without precoding. For MU-MIMO, a cell may transmit multiple data streams to multiple UEs (e.g., one data stream to each UE) on the same time-frequency resource with or without precoding. CoMP may include cooperative transmission and/or joint processing. For cooperative transmission, multiple cells may transmit one or more data streams to a single UE on a given time-frequency resource such that the data transmission is steered toward the intended UE and/or away from one or more interfered UEs. For joint processing, multiple cells may transmit multiple data streams to multiple UEs (e.g., one data stream to each UE) on the same time-frequency resource with or without precoding.

Wireless network 10 may support hybrid automatic retransmission (HARQ) in order to improve reliability of data transmission. For HARQ, a transmitter (e.g., an eNB) may send a transmission of a data packet (or transport block) and may send one or more additional transmissions, if needed, until the packet is decoded correctly by a receiver (e.g., a UE), or the maximum number of transmissions has been sent, or some other termination condition is encountered. The transmitter may thus send a variable number of transmissions of the packet.

Wireless network 10 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 10 may utilize frequency division duplex (FDD) or time division duplex (TDD). For FDD, the DL and UL may be allocated separate frequency channels, and DL transmissions and UL transmissions may be sent concurrently on the two frequency channels. For TDD, the DL and UL may share the same frequency channel, and DL and UL transmissions may be sent on the same frequency channel in different time periods.

FIG. 1B shows an example wireless communication system 100 for self-configuration of power control parameters with a serving cell 110, a neighboring cell 120, access terminals 130a and 130b, and a network controller 140. For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various examples access points may be referred to or implemented as base stations, NodeBs, eNodeBs, small cells, picocells, macrocells, and so on, while access terminals may be referred to or implemented as user equipment (UEs), mobile stations, and so on. It should also be appreciated that system 100, the serving cell 110, the neighboring cell 120, the access terminals 130, and the network controller 140 can include additional components not shown in FIG. 1B.

The serving cell 110 or neighboring cell 120 in the system 100 may provide access to one or more services (e.g., network connectivity) for one or more wireless terminals 130 (e.g., access terminal, UE, mobile entity, mobile device). For example, a LTE access point may communicate with one or more network entities (not shown) to facilitate wide area network connectivity. Such network entities may take various forms such as, for example, one or more radio and/or core network entities.

In various examples, the network entities may be responsible for or otherwise be involved with handling: network management (e.g., via an operation, administration, management, and provisioning entity), call control, session management, mobility management, gateway functions, interworking functions, or some other suitable network functionality. In a related aspect, mobility management may relate to or involve: keeping track of the current location of access terminals through the use of tracking areas, location areas, routing areas, or some other suitable technique; controlling paging for access terminals; and providing access control for access terminals. Also, two of more of these network entities may be co-located and/or two or more of such network entities may be distributed throughout a network.

The serving cell 110 may be an eNB serving access terminal 130a by providing one or more services. The serving cell 100 may be a macrocell (as shown in FIG. 1B) or a small cell (not shown). In the example illustrated in FIG. 1B, the serving cell 110 is a macrocell with a larger cell coverage area 115.

Similarly, the neighboring cell 120 may be an eNB serving access terminal 130b by providing one or more services. The neighboring cell 120 may be a macrocell (not shown) or a small cell (as shown in FIG. 1B). In the example illustrated in FIG. 1B, the neighboring cell 120 is a small cell with a smaller cell coverage area 125. The neighboring cell 120 may be one of a plurality of neighboring cells (not shown in FIG. 1B).

The access terminal 130a may be served by the serving cell 110. In the example shown in FIG. 1B, the access terminal 130a is located near a far edge of the larger cell coverage area 115. The access terminal 130a may concurrently be located near a far edge of the smaller cell coverage area 125. In this example scenario, uplink communications from the access terminal 130a to the serving cell 110 may have an interfering effect upon other network devices such as the neighboring cell 120 and other neighboring cells (not shown in FIG. 1B). In the example shown in FIG. 1B, where the serving cell 110 is a macrocell with a larger cell coverage area 115, the access terminal 130a at located near the far edge of the larger cell coverage area 115 may have a higher uplink transmit power. The higher uplink transmit power of the access terminal 130a may be needed due to the longer distance between the access terminal 130a and the macrocell 110. This higher uplink transmit power of the access terminal 130a may cause more interference than if the access terminal 130a used a lower uplink transmit power. Such interference may have a signficant negative impact on the neighboring cell's ability to provide service to the access terminal 130b.

The access terminal 130b may be served by the neighboring cell 110. In the example shown in FIG. 1B, the access terminal 130b is located near a far edge of the smaller cell coverage area 125. The access terminal 130b may concurrently be located near a far edge of the larger cell coverage area 115. In this example scenario, uplink communications from the access terminal 130b to the neighboring cell 120 may have an interfering effect upon other network devices such as the macrocell 110 and other neighboring cells (not shown in FIG. 1B). In the example shown in FIG. 1B, where the neighboring cell 110 is a small cell with a smaller cell coverage area 125, the access terminal 130b at located near the far edge of the smaller cell coverage area 125 may have a lower uplink transmit power than that of the access terminal 130a. The lower uplink transmit power of the access terminal 130b may be sufficient due to the shorter distance between the access terminal 130b and the small cell 120. This lower uplink transmit power of the access terminal 130b may cause less interference than the access terminal 130a described earlier. Such interference may only have a negligible negative impact on the macro cell's ability to provide service to the access terminal 130a.

The network controller 140 may connect to the serving cell 110 and the neighboring cell 120. The network controller 140 may provide coordination and control for these eNBs. Network controller 140 may include a single network entity or a collection of network entities. Network controller 140 may communicate with the serving cell 110 or the neighboring cell 120 via a backhaul. The eNBs may also communicate with one another, e.g., directly or indirectly via a wireless or wireline backhaul.

FIG. 1C shows a block diagram of an example wireless communication system 100c for self-configuration of power control parameters. A serving cell 150 may provide wireless services to an access terminal 170. The serving cell 150 may be located near a neighboring cell 160. The serving cell may communicate with a network controller 180 via backhaul.

The serving cell 150 may include a default power parameter determination component 152. The default power parameter determination component 152 may determine a default power parameter (P_{default}). In an example implementation, the default power parameter determination component 152 may receive a default power parameter from the network controller 180, an operations administration and management entity (OAM), or some other network entity (not shown in FIG. 1C).

The serving cell 150 may include a path-loss determination component 154. Path-loss is the reduction in power density of a wireless signal as it propagates through space. Path-loss may be due, for example, to a variety of environmental effects such as free-space loss, refection, diffraction, reflection, coupling loss, and absorption. The path-loss determination component 154 may determine a first path-loss for the access terminal 170 to the serving cell 150. The path-loss determination component 154 may also determine a second path-loss for the access terminal 170 to the neighboring cell 160. In an example implementation, the access terminal 170 may measure the first pass-loss and the second path-loss. The access terminal 170 may report the first pass-loss and the second path-loss to the serving cell 150.

The neighboring cell 160 may one of a plurality of neighboring cells (not shown in FIG. 1C) located near the serving cell 150. The neighboring cell 160 may include one or more uplink receiving (Rx) antenna 161 which receives uplink transmissions from mobile devices including the access terminal 170 as well as mobile devices served by the neighboring cell 160.

In an example implementation, the network controller 180 may determine the default power parameter optimized for a hypothetical scenario where a serving cell and a neighboring cell have equal cell sizes. In one implementation, the network controller 180 may determine an offset value based on a number of uplink receiving antennas of the neighboring cell 160. A cell equipped with more uplink receiving antennas may be able to better withstand interference from mobile devices such as the access terminal 170.

The serving cell 150 may include a power control parameter determination component 158. The power control parameter determination component 158 may determine a power control parameter P₀ based on the default power parameter and a path-loss difference. The pass-loss difference may be a difference between the first path-loss and the second path-loss. In one implementation, the power control parameter P₀ may be further based on the offset value. An example equation for determining the power control parameter P₀ is shown below in equation (1). In an example implementation, the serving cell 150 may automatically configure an uplink transmit power for the access terminal 170 based on the power control parameter P₀.

P₀=P_{default}−(PL_{Neighboring Cell}−PL_{Serving Cell})+Offset (1)

In another example implementation, another network entity outside of the serving cell 150 may include a default power parameter determination component, a path-loss determination component, and a power control parameter determination component. The another network entity, instead of the serving cell, may determine the power control parameter P₀. The another network entity, may for example, be an OAM, a network controller, or other suitable network entity. The another network entity may send the determined power control parameter P₀ to the serving cell 150.

FIG. 1D shows a block diagram of a second example wireless communication system for self-configuration of power control parameters. Unlike the system of FIG. 1C, the system of FIG. 1D does not use feedback from an access terminal in the determination of a power control parameter. A serving cell 150 may provide wireless services to an access terminal 170. The serving cell 150 may be located near a neighboring cell 160. The serving cell may communicate with a network controller 180 via backhaul.

The serving cell 150 may include a default power parameter determination component 152. The default power parameter determination component 152 may determine a default power parameter (P_{default}). In an example implementation, the default power parameter determination component 152 may receive a default power parameter from the network controller 180, an operations administration and management entity (OAM), or some other network entity (not shown in FIG. 1D).

The serving cell 150 may include a downlink power determination component 156. The downlink power determination component 156 may determine a downlink power of the serving cell 150. The downlink power refers to a power level for downlink transmissions from an access point. The downlink power determination component 156 may also determine a downlink power of the neighboring cell 160. In one implementation, the neighboring cell 160 may report the downlink power of the neighboring cell 160 to the serving cell 150 via an X2 connection. In another implementation, the neighboring cell 160 may report the downlink power of the neighboring cell 160 to the network controller 180, which may then report the downlink power of the neighboring cell 160 to the serving cell.

The neighboring cell 160 may one of a plurality of neighboring cells (not shown in FIG. 1D) located near the serving cell 150. The neighboring cell 160 may include one or more uplink receiving (Rx) antenna 161 which receives uplink transmissions from mobile devices including the access terminal 170 as well as mobile devices served by the neighboring cell 160.

In an example implementation, the network controller 180 may determine the default power parameter optimized for a hypothetical scenario where a serving cell and a neighboring cell have equal cell sizes. In one implementation, the network controller 180 may determine offset value based on a number of uplink receiving antennas of the neighboring cell 160. A cell equipped with more uplink receiving antennas may be able to better withstand interference from mobile devices such as the access terminal 170.

The serving cell 150 may include a power control parameter determination component 158. The power control parameter determination component 158 may determine a power control parameter P₀ based on the default power parameter and a downlink power difference. The downlink power difference may be a difference between the downlink power of the serving cell 150 and the downlink power of the neighboring cell 160. In one implementation, the power control parameter P₀ may be further based on the offset value. An example equation for determining the power control parameter P₀ is shown below in equation (2). In an example implementation, the serving cell 150 may automatically configure an uplink transmit power for the access terminal 170 based on the power control parameter P₀.

P₀=P_{default}−(DLPower_{Serving Cell}−DLPower_{Neighboring Cell})+Offset (2)

In another example implementation, another network entity outside of the serving cell 150 may include a default power parameter determination component, a downlink power determination component, and a power control parameter determination component. The another network entity, instead of the serving cell, may determine the power control parameter P₀. The another network entity, may for example, be an OAM, a network controller, or other suitable network entity. The another network entity may send the determined power control parameter P₀ to the serving cell 150.

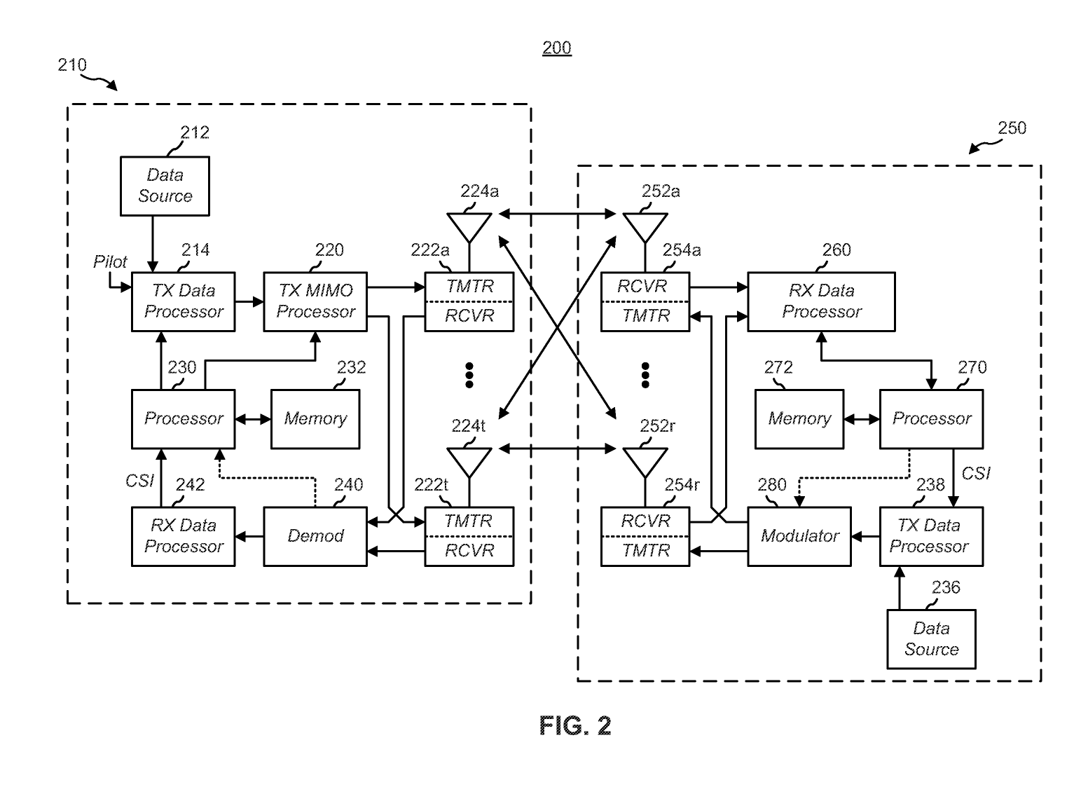

FIG. 2 illustrates a system 200 including a transmitter system 210 (also known as the access point, base station, or eNB) and a receiver system 250 (also known as access terminal, mobile device, or UE) in an LTE MIMO system 200. In the present disclosure, the transmitter system 210 may correspond to a WS-enabled eNB or the like, whereas the receiver system 250 may correspond to a WS-enabled UE or the like.

At the transmitter system 210, traffic data for a number of data streams is provided from a data source 212 to a transmit (TX) data processor 214. Each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain examples, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

As used herein, an access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio access point, a basic service set (BSS), an extended service set (ESS), a macrocell, a macro node, a microcell, a Home eNB (HeNB), a small cell, a pico node, or some other similar terminology.

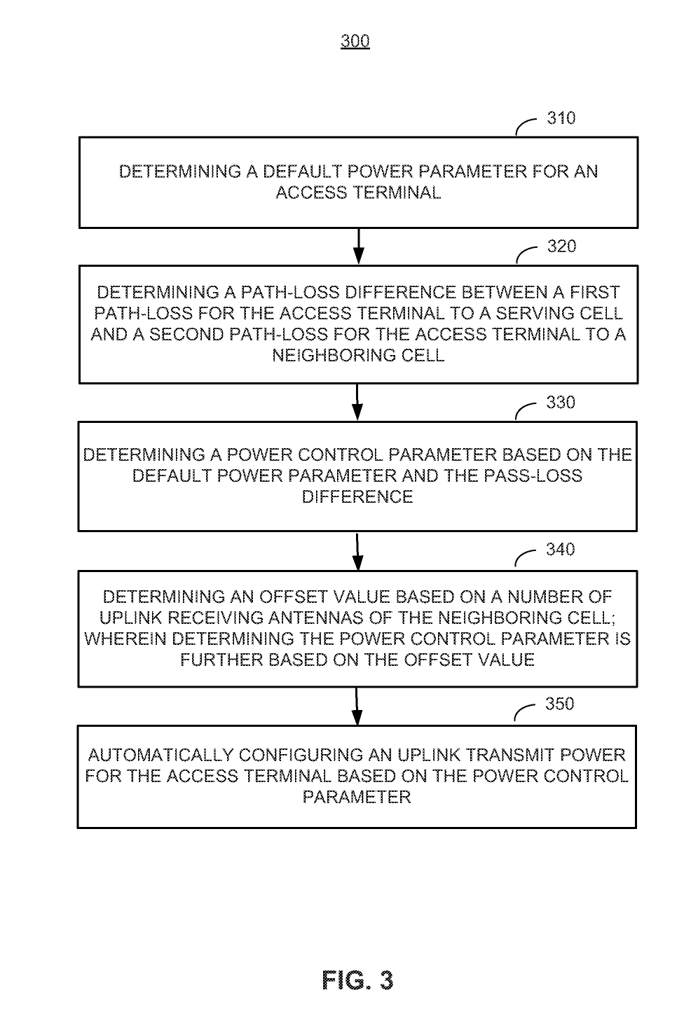

In accordance with one or more aspects of the examples described herein, with reference to FIG. 3, there is shown a methodology 300 for self-configuration of power control parameters. The method may be operable, such as, for example, by the serving cell 150, as shown in FIG. 1C, or the like.

The method 300 may involve, at 310 determining a default power parameter for an access terminal (e.g., access terminal 170 of FIG. 1C).

The method 300 may involve, at 320, determining a path-loss difference between a first path-loss for the access terminal to a serving cell (e.g., serving cell 150 of FIG. 1C) and a second path-loss for the access terminal to a neighboring cell (e.g., neighboring cell 160 of FIG. 1C).

The method 300 may optionally involve, at 330, determining a power control parameter based on the default power parameter and the pass-loss difference.

The method 300 may involve, at 340, determining an offset value based on a number of uplink receiving antennas of the neighboring cell; wherein determining the power control parameter is further based on the offset value.

The method 300 may optionally involve, at 350, automatically configuring an uplink transmit power for the access terminal based on the power control parameter.

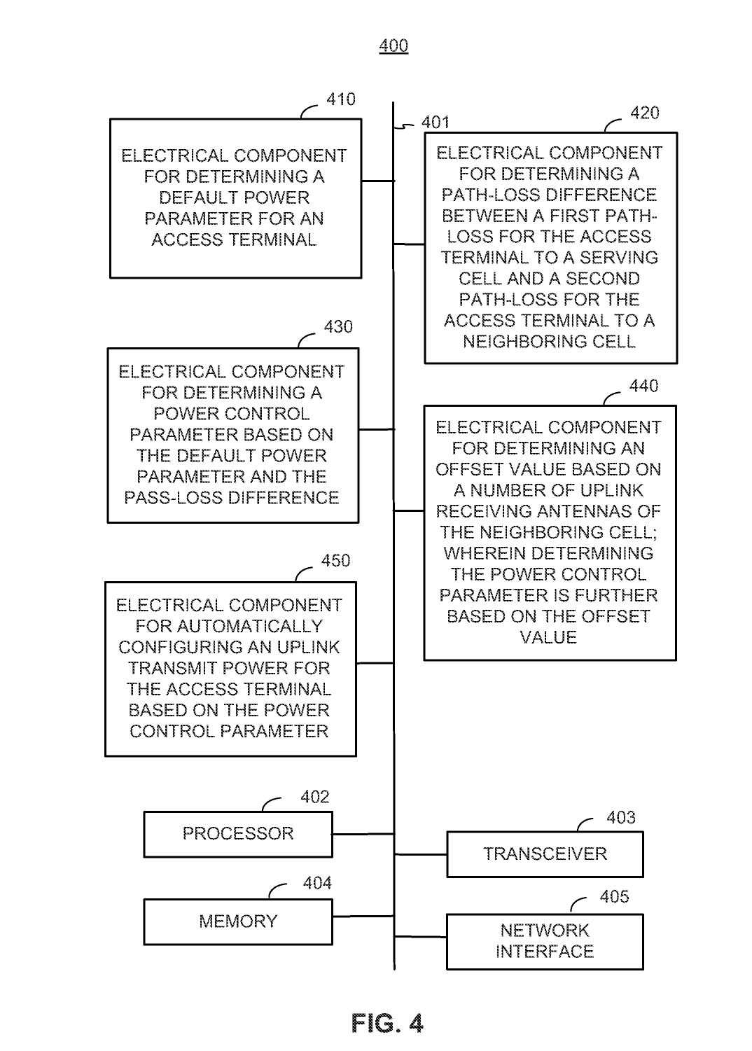

In accordance with one or more aspects of the examples described herein, FIG. 4 shows an example of an apparatus for self-configuration of power control parameters, in accordance with the methodology of FIG. 3. The exemplary apparatus 400 may be configured as a computing device or as a processor or similar device/component for use within. In one example, the apparatus 400 may include functional blocks that can represent functions implemented by a processor, software, or combination thereof (e.g., firmware). In another example, the apparatus 400 may be a system on a chip (SoC) or similar integrated circuit (IC).

In one example, apparatus 400 may include an electrical component or module 410 for determining a default power parameter for an access terminal

The apparatus 400 may include an electrical component 420 for determining a path-loss difference between a first path-loss for the access terminal to a serving cell and a second path-loss for the access terminal to a neighboring cell.

The apparatus 400 may include an electrical component 430 for determining a power control parameter based on the default power parameter and the pass-loss difference.

The apparatus 400 may include an electrical component 440 for determining an offset value based on a number of uplink receiving antennas of the neighboring cell; wherein determining the power control parameter is further based on the offset value.

The apparatus 400 may include an electrical component 450 for automatically configuring an uplink transmit power for the access terminal based on the power control parameter.

In further related aspects, the apparatus 400 may optionally include a processor component 402. The processor 402 may be in operative communication with the components 410-450 via a bus 401 or similar communication coupling. The processor 402 may effect initiation and scheduling of the processes or functions performed by electrical components 410-450.

In yet further related aspects, the apparatus 400 may include a radio transceiver component 403. A standalone receiver and/or standalone transmitter may be used in lieu of or in conjunction with the transceiver 403. The apparatus 400 may also include a network interface 405 for connecting to one or more other communication devices or the like. The apparatus 400 may optionally include a component for storing information, such as, for example, a memory device/component 404. The computer readable medium or the memory component 404 may be operatively coupled to the other components of the apparatus 400 via the bus 401 or the like. The memory component 404 may be adapted to store computer readable instructions and data for affecting the processes and behavior of the components 410-450, and subcomponents thereof, or the processor 402, or the methods disclosed herein. The memory component 404 may retain instructions for executing functions associated with the components 410-450. While shown as being external to the memory 404, it is to be understood that the components 410-450 can exist within the memory 404. It is further noted that the components in FIG. 4 may comprise processors, electronic devices, hardware devices, electronic sub-components, logical circuits, memories, software codes, firmware codes, etc., or any combination thereof. Persons skilled in the art will appreciate that the functionalities of each component of apparatus 400 can be implemented in any suitable component of the system or combined in any suitable manner.

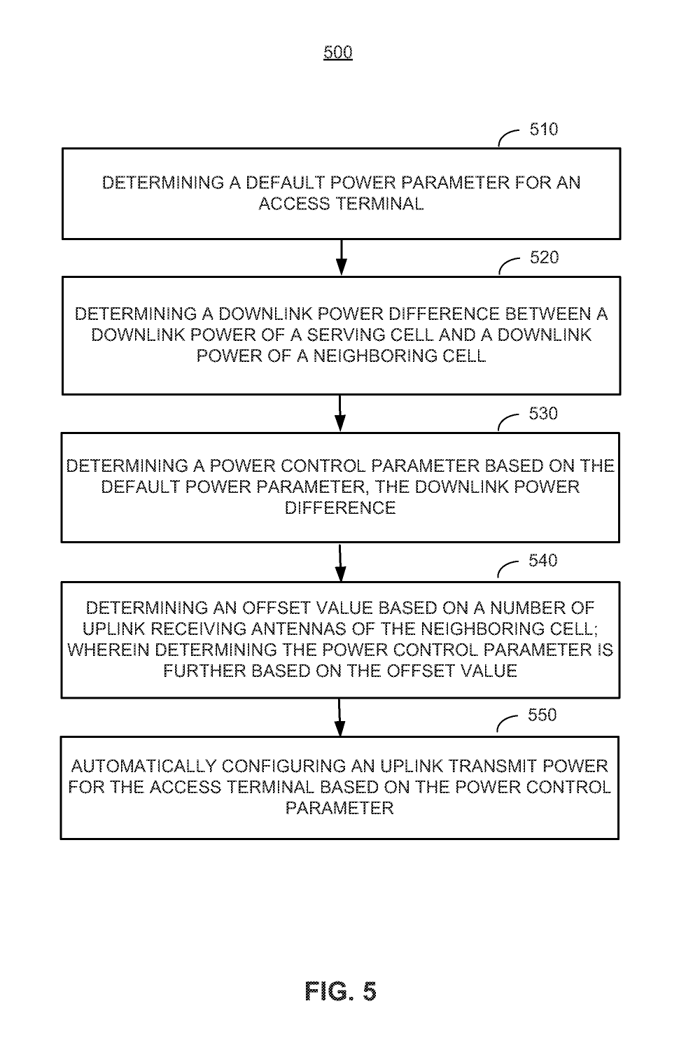

In accordance with one or more aspects of the examples described herein, with reference to FIG. 5, there is shown a methodology 500 for self-configuration of power control parameters. The method may be operable, such as, for example, by the serving cell 150, as shown in FIG. 1C, or the like.

The method 500 may involve, at 510, determining a default power parameter for an access terminal (e.g., access terminal 170 of FIG. 1C).

The method 500 may involve, at 520, determining a downlink power difference between a downlink power of a serving cell (e.g., serving cell 150 of FIG. 1C) and a downlink power of a neighboring cell (e.g., neighboring cell 160 of FIG. 1C).

The method 500 may involve, at 530, determining a power control parameter based on the default power parameter, the downlink power difference.

The method 500 may optionally involve, at 540, determining an offset value based on a number of uplink receiving antennas of the neighboring cell; wherein determining the power control parameter is further based on the offset value.

The method 500 may optionally involve, at 550, automatically configuring an uplink transmit power for the access terminal based on the power control parameter.

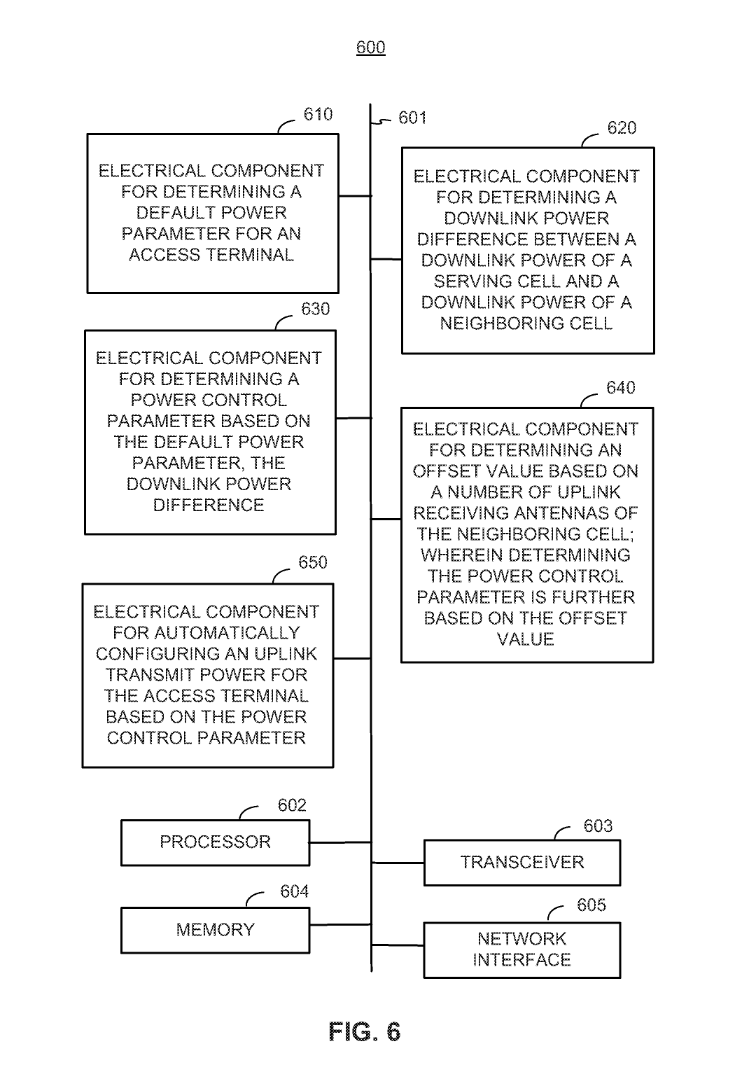

In accordance with one or more aspects of the examples described herein, FIG. 6 shows an example of an apparatus for self-configuration of power control parameters, in accordance with the methodology of FIG. 5.

In one example, apparatus 600 may include an electrical component or module 610 for determining a default power parameter for an access terminal

The apparatus 600 may include an electrical component 620 for determining a downlink power difference between a downlink power of a serving cell and a downlink power of a neighboring cell.

The apparatus 600 may include an electrical component 630 for determining a power control parameter based on the default power parameter, the downlink power difference.

The apparatus 600 may include an electrical component 640 for determining an offset value based on a number of uplink receiving antennas of the neighboring cell; wherein determining the power control parameter is further based on the offset value.

The apparatus 600 may include an electrical component 650 for automatically configuring an uplink transmit power for the access terminal based on the power control parameter.

For the sake of conciseness, the rest of the details regarding apparatus 600 are not further elaborated on; however, it is to be understood that the remaining features and aspects of the apparatus 600 are substantially similar to those described above with respect to apparatus 400 of FIG. 4. Persons skilled in the art will appreciate that the functionalities of each component of apparatus 600 can be implemented in any suitable component of the system or combined in any suitable manner.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein, but is to be accorded the widest scope consistent with the principles and novel features disclosed herein.

What is claimed is:

1. A method of wireless communication, operable by a network entity, comprising:
determining a default power parameter for an access terminal;
determining a path-loss difference between a first path-loss for the access terminal to a serving cell and a second path-loss for the access terminal to a neighboring cell; and
determining a power control parameter based on the default power parameter and the pass-loss difference.

2. The method of claim 1, further comprising:
determining an offset value based on a number of uplink receiving antennas of the neighboring cell;
wherein determining the power control parameter is further based on the offset value.

3. The method of claim 1, further comprising automatically configuring an uplink transmit power for the access terminal based on the power control parameter.

4. The method of claim 1, wherein the neighboring cell is one of a plurality of neighboring cells, and the second path-loss is equal to a lowest path-loss amongst the plurality of neighboring cells.

5. The method of claim 1, wherein determining the power control parameter comprises determining a difference between the default power parameter and the pass-loss difference.

6. The method of claim 1, wherein the first pass-loss and the second pass-loss to are measured by the access terminal and reported to the network entity.

7. The method of claim 1, wherein the network entity comprises the serving cell.

8. The method of claim 1, wherein the network entity comprises at least one of an operations administration and management (OAM) entity or a network controller.

9. The method of claim 1, wherein the default power parameter is received from at least one of an operations administration and management (OAM) entity or a network controller.

10. A wireless communication apparatus, comprising:
at least one processor configured to:
determine a default power parameter for an access terminal;
determine a path-loss difference between a first path-loss for the access terminal to a serving cell and a second path-loss for the access terminal to a neighboring cell; and
determine a power control parameter based on the default power parameter and the pass-loss difference.

11. The apparatus of claim 10, wherein the at least one processor is further configured to:
determine an offset value based on a number of uplink receiving antennas of the neighboring cell;
wherein determining the power control parameter is further based on the offset value.

12. The apparatus of claim 10, wherein the at least one processor is further configured to automatically configure an uplink transmit power for the access terminal based on the power control parameter.

13. The apparatus of claim 10, wherein the neighboring cell is one of a plurality of neighboring cells, and the second path-loss is equal to a lowest path-loss amongst the plurality of neighboring cells.

14. The apparatus of claim 10, wherein the at least one processor is configured to determine the power control parameter by determining a difference between the default power parameter and the pass-loss difference.

15. A computer program product, comprising:
a non-transitory computer-readable medium comprising:
code for determining a default power parameter for an access terminal;
code for determining a downlink power difference between a downlink power of a serving cell and a downlink power of a neighboring cell; and
code for determining a power control parameter based on the default power parameter, the downlink power difference.

16. The computer program product of claim 15, the non-transitory computer-readable medium further comprising:
code for determining an offset value based on a number of uplink receiving antennas of the neighboring cell;
wherein determining the power control parameter is further based on the offset value.

17. The computer program product of claim 15, the non-transitory computer-readable medium further comprising code for automatically configuring an uplink transmit power for the access terminal based on the power control parameter.

18. The computer program product of claim 15, wherein the neighboring cell is one of a plurality of neighboring cells, and the downlink power of the neighboring cell is equal to a lowest downlink power amongst the plurality of neighboring cells.

19. The computer program product of claim 15, wherein determining the power control parameter comprises determining a difference between the default power parameter and the downlink power difference.

20. The computer program product of claim 15, wherein the downlink power of the neighboring cell is reported by the neighboring cell to the network entity.

21. The computer program product of claim 15, wherein the downlink power of the neighboring cell is reported via an X2 interface of a backhaul.

22. The computer program product of claim 15, wherein the network entity comprises the serving cell.

23. The computer program product of claim 15, wherein the network entity comprises at least one of an operations administration and management (OAM) entity or a network controller.

24. The computer program product of claim 15, wherein the default power parameter is received from at least one of an operations administration and management (OAM) entity or a network controller.

25. A wireless communication apparatus, comprising:
means for determining a default power parameter for an access terminal;
means for determining a downlink power difference between a downlink power of a serving cell and a downlink power of a neighboring cell; and
means for determining a power control parameter based on the default power parameter, the downlink power difference.

26. The apparatus of claim 25, further comprising:
means for determining an offset value based on a number of uplink receiving antennas of the neighboring cell;
wherein determining the power control parameter is further based on the offset value.

27. The apparatus of claim 25, further comprising means for automatically configuring an uplink transmit power for the access terminal based on the power control parameter.

28. The apparatus of claim 25, wherein the neighboring cell is one of a plurality of neighboring cells, and the downlink power of the neighboring cell is equal to a lowest downlink power amongst the plurality of neighboring cells.

29. The apparatus of claim 25, wherein determining the power control parameter comprises determining a difference between the default power parameter and the downlink power difference.

30. The apparatus of claim 25, wherein the downlink power of the neighboring cell is reported by the neighboring cell to the network entity.
